(19) United States
(12) Patent Application Publication
(10) Pub. No.: US 2012/0175547 A1
(43) Pub. Date: Jul. 12, 2012

(54) COMPOUND MATERIAL COMPRISING A METAL AND NANOPARTICLES

(75) Inventor: Horst Adams, Altstatten (CH)

(73) Assignee: BAYER MATERIALSCIENCE AG, Leverkusen (DE)

(21) Appl. No.: 13/496,564

(22) PCT Filed: Aug. 16, 2010
(86) PCT No.: PCT/EP10/61890

§ 371 Date: Mar. 16, 2012

(30) Foreign Application Priority Data
Sep. 17, 2009 (EP) PCT/EP2009/006737
Jan. 28, 2010 (EP) PCT/EP2010/000520

(51) Int. Cl. C09K 5/00; B02C 17/16; B82Y 30/00; B82Y 40/00

(52) U.S. Cl. 252/71; 241/27; 977/773; 977/742; 977/752; 977/900

(57) ABSTRACT

The present invention relates to compound materials comprising a metal and nanoparticles, in particular carbon nano tubes (CNT), characterized in that the compound has a metal crystallite structure of crystallites having an average size which is in the range of higher than 100 nm and up to 200 nm, preferably between 120 nm and 200 nm.

### TECHNICAL FIELD

The present invention relates to compound materials comprising a metal and nanoparticles, in particular carbon nano tubes (CNT), characterized in that the compound has a metal crystallite structure of crystallites having an average size which is in the range of higher than 100 nm and up to 200 nm, preferably between 120 nm and 200 nm.

### BACKGROUND ART

Carbon nano tubes (CNT), sometimes also referred to as “carbon fibrils” or “hollow carbon fibrils”, are typically cylindrical carbon tubes having a diameter of 3 to 100 nm and a length which is a multiple of their diameter. CNTs may consist of one or more layers of carbon atoms and are characterized by cores having different morphologies.

CNTs have been known from the literature for a long time. While Iijima (s. Iijima, Nature 354, 56-58, 1991) is generally regarded as the first to discover CNTs, in fact fibre shaped graphite materials having several graphite layers have been known since the 1970s and 1980s. For example, in GB 14 699 30 A1 and EP 56 004 A2, Tates and Baker described for the first time the deposition of very fine fibrous carbon from a catalytic decomposition of hydrocarbons. However, in these publications the carbon filaments which are produced based on short-chained carbohydrates are not further characterized with respect to their diameter.

The most common structure of carbon nano tubes is cylindrical, wherein the CNT may be either comprised of a single graphene layer (single-wall carbon nano tubes) or of a plurality of concentric graphene layers (multi-wall carbon nano tubes). Standard ways to produce such cylindrical CNTs are based on arch discharge, laser ablation, CVD and catalytic CVD processes. In the above mentioned article by Iijima (Nature 354, 56-58, 1991), the formation of CNTs having two or more graphene layers in the form of concentric seamless cylinders using the arch discharge method is described. Depending on a so-called “roll up vector”, chiral and antichiral arrangements of the carbon atoms with respect to the CNT longitudinal axis are possible.

In an article by Bacon et. al., J. Appl. Phys. 34, 1960, 283-290, a different structure of CNT consisting of a single continuous rolled up graphene layer is described for the first time, which is usually referred to as the “scroll type”. A similar structure comprised of a discontinuous graphene layer is known under the name “onion type” CNT. Such structures have later also been found by Zhou et. al, Science, 263, 1994, 1744-1747 and by Lavin et. al., Carbon 40, 2002, 1123-1130.

As is well known, CNTs have truly remarkable characteristics with regard to electric conductivity, heat conductivity and strength. For example, CNTs have a hardness exceeding that of diamond and a tensile strength ten times higher than steel. Consequently, there has been a continuous effort to use CNTs as constituent in compound or composite materials such as ceramics, polymer materials or metals trying to transfer some of these advantageous characteristics to the compound material.

From US 2007/0134496 A1, a method of producing a CNT dispersed composite material is known, in which a mixed powder of ceramics and metal and long-chain carbon nano tubes are kneaded and dispersed by a ball mill, and the dispersed material is sintered using discharge plasma. If aluminum is used for the metal, the preferred particle size is 50 to 150 μm.

A similar method in which carbon nano materials and metal powders are mixed and kneaded in a mechanical alloying process such as to produce a composite CNT metal powder is described in JP 2007 154 246 A.

Another related method of obtaining a metal-CNT-composite material is described in WO 2006/123 859 A1. Herein again, metal powder and CNTs are mixed in a ball mill at a milling speed of 300 rpm or more. One of the main objects of this prior art is to ensure a directionality of the CNTs in order to enhance the mechanical and electrical properties. According to this patent document, the directionality is imparted to the nano fibrils by application of a mechanical mass flowing process to the composite material with the nano fibrils uniformly dispersed in the metal, where the mass flowing process could for example be extrusion, rolling or injection of the composite material.

WO 2008/052 642 and WO 2009/010 297 of the present inventors disclose a further method of producing a composite material containing CNTs and a metal. Herein, the composite material is produced by mechanical alloying using a ball mill, where the balls are accelerated to very high velocities up to 11 m/s or even 14 m/s. The resulting composite material is characterized by a layered structure of alternating metal and CNT layers, where the individual layers of the metal material may be between 20 and 200,000 nm thick and the individual layers of the CNT may be between 20 and 50,000 nm thickness. The layer structure of this prior art is shown in FIG. 11b.

As is further shown in these patent documents, by introducing 6.0 wt % CNTs in a pure aluminum matrix, the tensile strength, hardness and module of elasticity can be significantly increased as compared to pure aluminum. However, due to the layer structure, the mechanical properties are not isotropic.

In order to provide for a homogenous and isotropic distribution of CNTs, in JP 2009 03 00 90, yet an alternative way of forming the CNT metal compound material is proposed. According to this document, a metallic powder having an average primary particle size of 0.1 μm to 100 μm is immersed in a solution containing CNTs, and the CNTs are attached to the metal particles by hydrophilization, thereby forming a mesh-shaped coating film on top of the metal powder particles. The CNT coated metallic powder can then be further processed in a sintering process. Also, a stacked metal composite may be formed by stacking the coated metal composite on a substrate surface. The resultant composite is reported to have superior mechanical strength, electric conductivity and thermal conductivity.

As is apparent from the above discussion of the prior art, the same general idea of dispersing CNTs in metal can be put to practice in numerous different ways, and the resulting composite materials may have different mechanical, electrical and thermal conductivity properties.

It is to be further understood that the above referenced prior art is still in an early stage of development, i.e. it remains yet to be shown what type of composites can eventually be produced on a large enough scale and under economically reasonable conditions to actually find use in industry. Further, while the mechanical properties of the compound materials as such have barely been examined, it remains to be shown how the composite materials behave under further processing into an article, and in particular, to what extent the beneficial properties of the composite material as a source material can be carried over to the finished article produced therefrom and be maintained under use of the article.

While various CNT-containing metals have been described, performance of those compounds in largescale applications remains to be proven and fine-tuned by practical experience. It has now been found, surprisingly, that properties in isotropic CNT-Aluminium-alloys are superior when the alloy possesses a distinct range of crystallite size and very specific CNT's are used.

It is thus an object of the invention to provide an improved composite material comprising a metal and nanoparticles having mechanical properties such as hardness, tensile strength and Young modulus, heat-resistance, i.e. high-temperature stability, which are further enhanced when compared to the materials of the prior art, as well as a method for producing the same.

It is a further and equally important object of the invention to provide such a composite material which shows these superior beneficial mechanical properties under further processing to a semimanufactured or finished product, preserving the beneficial properties while the product is in use. This will allow that the material can be manufactured with great precision and efficiency while preserving the advantageous mechanical properties, and that the finished product itself will have a high-temperature stability as well.

As regards the manufacturing method, a further object of the invention is to provide a method which allows for a simple and cost-efficient handling of the separate constituents as well as of the composite material while minimizing the potential for exposure for persons involved in the production.

### SUMMARY OF THE INVENTION

In order to meet the above objects according to one embodiment, a method of producing a composite material comprising a metal and nanoparticles, in particular carbon nanotubes (CNT) is provided, in which a metal powder and the nanoparticles are processed by mechanical alloying, such as to form a composite comprising metal crystallites having an average size in the range of higher than 100 nm and up to 200 nm, preferably between 120 nm and 200 nm.

Accordingly, the composite material differs structurally from the composite of JP 2009 03 00 90 or US 2007/0134496 in that the metal crystallites are at least one order of magnitude smaller.

Also, the composite material of the invention differs from previous inventions of the inventors in that in the present composite, independent metal crystallites of below 200 nm but more than 100 nm are formed, while according to the above patent documents the compound has a structure of alternating thin layers of metal and CNT, in which the in-plane extension of the metal layer however is way beyond 200 nm.

In EP 1918249 A1 and WO 2009/010297 A1, the use of CNTs and CNT agglomerates having a maximum lateral length of 50.000 nm has been disclosed. However, the use of a specific type of CNTs as described later on in this specification (further below in this specification referred to as “CNT-INV”) proves to be extremely useful with regard to processing of the educts, and to resulting properties of the inventive composition and of the semi-finished and finished products made therefrom.

It has been found in experiments that the strengthening effects of the CNTs on mechanical alloys is most pronounced when the average crystallite size in the CNT-metal compound is in the range of higher than 100 nm and up to 200 nm, preferably between 120 nm and 200 nm.

When compared to the compound materials of the prior art, the alloys thus produced have superior properties inter alia with regard to Young modulus and hardness. Due to their high temperature stability, these properties are preserved when the alloys are or have been exposed to high temperatures.

In some embodiments of the invention, some CNTs are also contained or embedded in crystallites. One can think of this as a CNT sticking out like a “hair” from a crystallite. These embedded CNTs are believed to play an important role in preventing grain growth and internal relaxation, i.e. preventing a decrease of the dislocation density when energy is supplied in form of pressure and/or heat upon compacting the compound material. Using mechanical alloying techniques as e.g. in EP 1 918 249 A1, paragraphs [001-0013] (hereby incorporated by reference), CNTs are embedded in crystallites. In particular, when using CNT, the crystallites of the inventive CNT-metal compound are stabilized in sizes of higher than 100 nm and up to 200 nm, preferably between 120 nm and 200 nm.

Preferably, the metal of the compound is a light metal, and in particular, Al, Mg, Ti or an alloy including one or more of the same. Alternatively, the metal may be Cu or a Cu alloy. As regards aluminum as a metal component, the invention allows to circumvent many problems currently encountered with Al alloys. While high strength Al alloys are known, such as Al7xxx incorporating Zinc or Al8xxx incorporating Li according to standard EN 573-3/4, unfortunately, coating these alloys by anodic oxidation proves to be difficult. Also, if different Al alloys are combined, due to a different electro-chemical potential of the alloys involved, corrosion may occur in the contact region. On the other hand, while Al alloys of the series 1xxx, 3xxx and 5xxx based on solid-solution hardening can be coated by anodic oxidation, they have comparatively poor mechanical properties, a low temperature stability and can only be hardened to a quite narrow degree by cold working.

In contrast to this, if pure aluminum or an aluminum alloy forms the metal constituent of the composite material of the invention, an aluminum based composite material can be provided which due to the nano-stabilization effect has a strength and hardness comparable with or even beyond high strength aluminum alloys available today, which also has an increased high-temperature stability due to the nano-stabilization and is open for anodic oxidation. If a high-strength aluminum alloy is used as the metal of the composite of the invention, the strength of the compound can even be further raised. Also, by adequately adjusting the percentage of CNTs in the composite, the mechanical properties can be adjusted to a desired value. Therefore, materials having the same metal component but different concentrations of CNT and thus different mechanical properties can be manufactured, which will have the same electro-chemical potential and therefore will not be prone to corrosion when connected with each other.

It has been found that the tensile strength and the hardness can be varied approximately proportionally with the content of CNT in the composite material. For light metals, such as aluminum, it has been found that the Vickers hardness increases nearly lineally with the CNT content. At a CNT content of about 9.0 wt %, the composite material becomes extremely hard and brittle. Accordingly, depending on the desired mechanical properties, a CNT content from 0.5 to 10.0 wt % will be preferable. In particular, a CNT content in the range of 5.0 to 9.0% is extremely useful as it allows to make composite materials of extraordinary strength in combination with the aforementioned advantages of nano-stabilization, in particular high-temperature stability. In another preferred embodiment, the CNT content is between 3.0 and 6.0 wt %.

The most pronounced effects may be achieved when using CNTs which in form of a powder of tangled CNT-agglomerates have a mean size sufficiently large to ensure easy handling because of a low potential for dustiness. Herein, preferably at least 95% of the CNT-agglomerates have a cluster size larger than 100 ƒm. Preferably, the mean diameter of the CNT-agglomerates is between 0.05 and 5.0 mm, preferably 0.1 and 2.0 mm and most preferably 0.2 and 1.0 mm

Accordingly, the nanoparticles to be processed with the metal powder can be easily handled e.g. with regard to dustiness and filtering by standard filters. Further, the powder comprised of agglomerates being larger than 100 μm, has a pourability and flowability which allows an easy handling of the CNT source material.

One might expect at first sight that it could be difficult to uniformly disperse the CNT on a nano scale while providing them in the form of highly entangled agglomerates on a millimetre scale, but it has been confirmed by the inventor that the tangled structure and the use of large CNT-agglomerates even helps to preserve the integrity of the CNT upon the mechanical alloying at high kinetic energies.

Further, the length-to-diameter ratio of the CNT, also called aspect ratio, is preferably larger than 3, more preferably larger than 5 but most preferably smaller than 15. A high aspect ratio of the CNT again assists in the nano-stabilization of the metal crystallites.

In an advantageous embodiment of the present invention, at least a fraction of the CNT have a scrolled structure comprised of one or more rolled up graphite layers, each graphite layer consisting of two or more graphene layers on top of each other. This type of nanotubes has for the first time been described in DE 10 2007 044 031 A1. This new type of CNT structure is called a “multi-scroll” structure to distinguish it from “single-scroll” structures comprised of a single rolled-up graphene layer. The relationship between multi-scroll and single-scroll CNTs is therefore analogous to the relationship between single-wall and multi-wall cylindrical CNTs. The multi-scroll CNTs have a spiral shaped cross section and typically comprise 2 or 3 graphite layers with 6 to 12 graphene layers each.

The multi-scroll type CNT have found to be extraordinarily suitable for the above mentioned nano-stabilization. One of the reasons is that the multi-scroll CNT have the tendency to not extend along a straight line but to have a curvy or kinky, multiply bent shape, which is also the reason why they tend to form large agglomerates of highly tangled CNTs. This tendency to form a curvy, bent and tangled structure facilitates the formation of a three-dimensional network interlocking with the crystallites and stabilizing them.

A further reason why the multi-scroll structure is so well suited for nano-stabilization is believed to be that the individual layers tend to fan out when the tube is bent like the pages of an open book, thus forming a rough structure for interlocking with the crystallites which in turn is believed to be one of the mechanisms for stabilization of defects.

Further, since the individual graphene and graphite layers of the multi-scroll CNT apparently are of continuous topology from the center of the CNT towards the circumference without any gaps, this again allows for a better and faster intercalation of further materials in the tube structure, since more open edges are available forming an entrance for intercalates as compared to single-scroll CNTs as described in Carbon 34, 1996, 1301-03, or as compared to CNTs having an onion type structure as described in Science 263, 1994, 1744-47.

When processing conventional CNT at high kinetic energies, the CNT may be worn down or destroyed to an extent that the interlocking effect with the metal crystallites, i.e. the nano-stabilization no longer occurs. According to the present invention, CNT as described in DE 10 2007 044 031 A1 prove to be very stable in the production process of the inventive CNT-metal compound. Thus, the respective CNT are most effective in stabilizing the crystallite structure and enhancing the macroscopic properties of the CNT-metal compound.

In a preferred embodiment, the processing of the respective CNT is carried out until the length of the CNT's is in the order of magnitude of the average size or average diameter of the metal crystallites, e.g. higher than 100 nm and up to 200 nm, preferably between 120 nm and 200 nm

In a preferred embodiment, at least a fraction of the nanoparticles are functionalized, in particular surface roughened prior to the mechanical alloying. When the nanoparticles are formed by multi-wall or multi-scroll CNTs, the roughening may be performed by causing at least the outermost layer of at least some of the CNTs to break by submitting the CNTs to high pressure, such as a pressure of 5.0 MPa or higher, preferably 7.8 MPa or higher, as will be explained below with reference to a specific embodiment. Due to the roughening of the nanoparticles, the interlocking effect with the metal crystallites and thus the nano-stabilization is further increased.

In a preferred embodiment, the processing is conducted such as to increase and stabilize the dislocation density of the crystallites by the nanoparticles sufficiently to increase the average Vickers hardness of the composite material to exceed the Vickers hardness of the original metal by 40% or more, preferably by 80% or more.

In order to avoid sticking or baking of the metal particles during processing, it has proven to be very efficient to add some CNTs already during a first stage which may then serve as a milling agent preventing sticking and/or baking of the metal component. This fraction of the CNT will be sacrificed, as it might be completely milled down and not have any noticeable property enhancing effect. Accordingly, the fraction of CNT added will be kept as small as possible as long as it prevents sticking or baking of the metal constituent.

### BRIEF DESCRIPTION OF THE FIGURES

FIG. 1 is a schematic diagram illustrating the production setup for high quality CNTs.

FIG. 2 is a sketch schematically showing the generation of CNT-agglomerates from agglomerated primary catalyst particles.

FIG. 3 is an SEM picture of a CNT-agglomerate.

FIG. 4 is a close-up view of the CNT-agglomerate of FIG. 3 showing highly en-tangled CNTs.

FIG. 5 is a graph showing the size distribution of CNT-agglomerates obtained with a production setup shown in FIG. 1

FIG. 6a is an SEM image of CNT-agglomerates prior to functionalization.

FIG. 6b is an SEM image of the same CNT-agglomerates after functionalization.

FIG. 6c is a TEM image showing a single CNT after functionalization.

FIG. 7 is a schematic diagram showing a setup for spray atomization of liquid alloys into an inert atmosphere.

FIGS. 8a and 8b show sectional side and end views respectively of a ball mill designed for high energy milling.

FIG. 9 is a conceptional diagram showing the mechanism of mechanical alloying by high energy milling.

FIG. 10 is a diagram showing the rotational frequency of the HEM rotor versus time in a cyclic operation mode.

FIG. 11a shows the nano structure of a compound of the invention in a section through a compound particle.

FIG. 11b shows, in comparison to FIG. 11a, a similar sectional view for the compound material as known from WO 2008/052642 A1 and WO 2009/010297 A1.

FIG. 12 shows an SEM image of the composite material according to an embodiment of the invention in which CNTs are embedded in metal crystallites.

FIG. 13 shows the same SEM image, the white lines illustrating the boundaries of the crystallites.

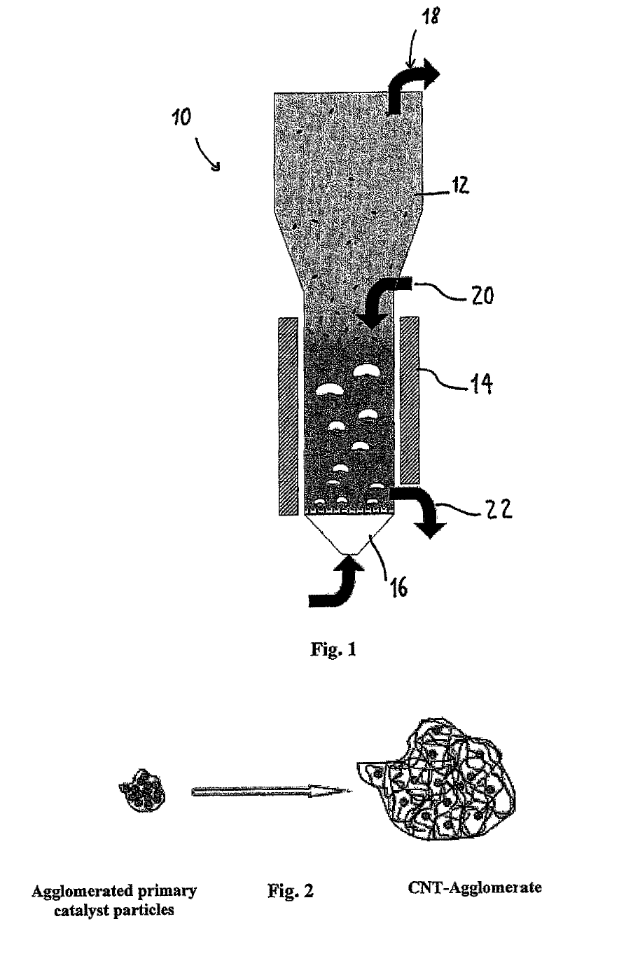

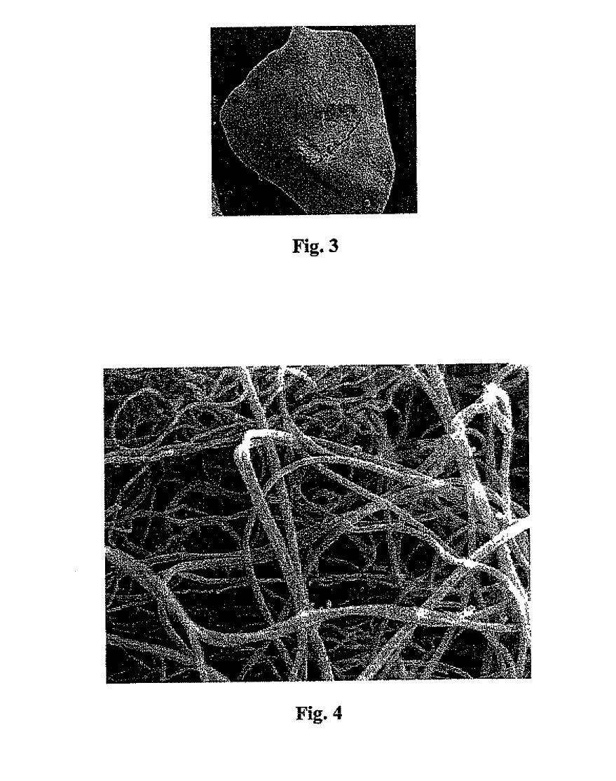

### DESCRIPTION OF A PREFERRED EMBODIMENT

For the purposes of promoting an understanding of the principles of the invention, reference will now be made to the preferred embodiment illustrated in the drawings and specific language will be used to describe the same. It will, nevertheless, be understood that no limitation of the scope of the invention is thereby intended, such alterations and further modifications in the illustrated product, method and use and such further applications of the principles of the invention as illustrated therein being contemplated as would normally occur now or in the future to one skilled in the art to which the invention relates.

In the following, a processing strategy for producing constituent materials and for producing a composite material from the constituent materials will be explained. Also, exemplary use of the composite material in different ways of compacting will be discussed.

In the preferred embodiment, the processing strategy comprises the following steps:
1.) production of high quality CNTs,
2.) optional functionalization of the CNTs,
3.) spray atomisation of liquid metal or alloys into inert atmosphere,
4.) high energy milling of metal powders optionally produced by spray atomisation of liquid metal or alloys into inert atmosphere,
5.) mechanical dispersion of CNT in the metal by mechanical alloying,
6.) compacting of metal-CNT composite powders, and
7.) further processing of compacted samples.

It is to be understood that the first five steps represent an embodiment of the production method, in which a composite material according to an embodiment of the invention is obtained. The last two processing steps refer to an exemplary use of the composite material according to an embodiment of the invention.

### 1. High Quality CNT

In a preferred embodiment, CNTs of the multi-scroll type as known from DE 10 2007 044 031 A1 are used. These CNTs are commercially available as Baytubes® C150 P from Bayer MaterialScience AG, Germany. Typical values for product properties are shown in the following table:

TABLE 1

| Properties | Value | Unit | Method |
|---|---|---|---|
| C-Purity | >95 | wt % | ashing |
| Free amorphous carbon | — | wt % | TEM |
| Outer mean diameter | ~13 | nm | TEM |
| Inner mean diameter | ~4 | nm | TEM |
| Length | 1->10 | μm | SEM |
| Bulk density | 130-150 | kg/m³ | EN ISO 60 |

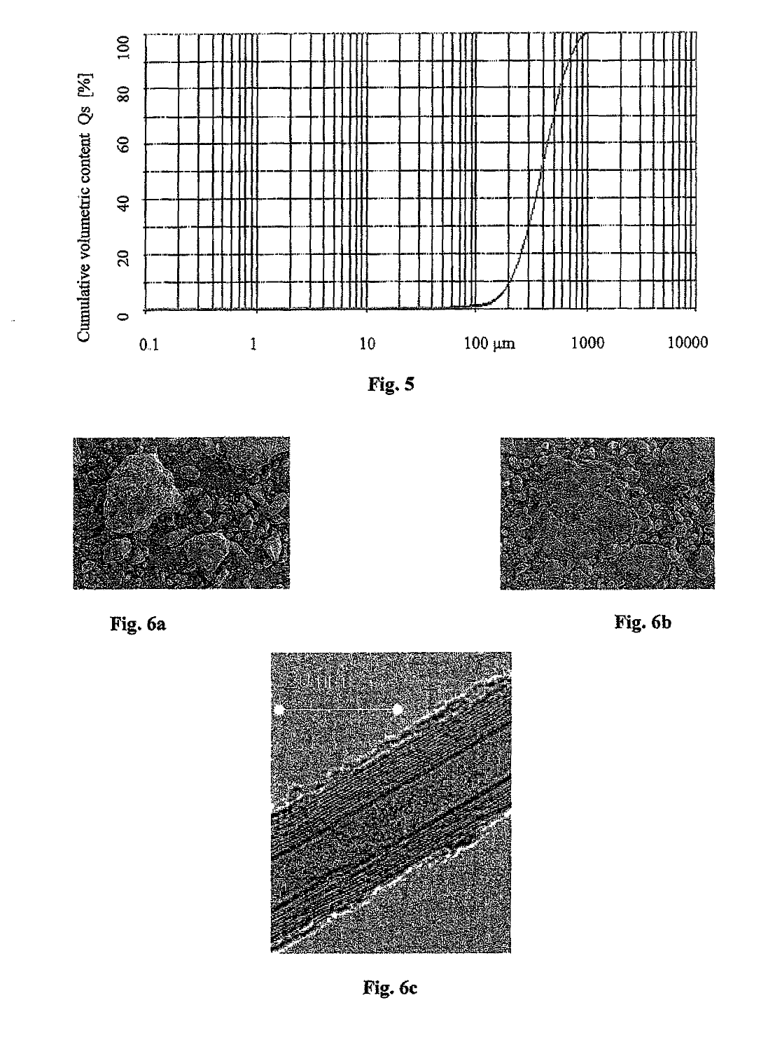

FIG. 5 shows a graph of the particle-size distribution of the CNT-agglomerates. The abscissa represents the particle size in μm, while the ordinate represents the cumulative volumetric content. As can be seen from the diagram in FIG. 5, almost all of the CNT-agglomerates have a size larger than 100 μm. This means that practically all of the CNT-agglomerates can be filtered by standard filters. These CNT-agglomerates have a low respirable dustiness under EN 15051-B. Thus, the extraordinarily large CNT-agglomerates used in the preferred embodiment of the invention allow for a safe and easy handling of the CNT, which again is of highest importance when it comes to transferring the technology from the laboratory to the industrial scale. Also, due to the large CNT-agglomerate size, the CNT powder has a good pourability, which also greatly facilitates the handling. Thus, the CNT-agglomerates allow to combine macroscopic handling properties with nanoscopic material characteristics.

In order to meet the above objects according to one embodiment, a method of producing a composite material comprising a metal and nanoparticles, in particular carbon nano tubes (CNT) is provided, in which a metal powder and the nanoparticles are processed by mechanical alloying, such as to form a composite comprising metal crystallites having an average size which is in the range of higher than 100 nm and up to 200 nm, preferably between 120 nm and 200 nm.

### 2. Functionalization of CNT

The CNTs may be functionalized prior to performing the mechanical alloying. The purpose of the functionalizing is to treat the CNTs such that the nano-stabilization of the metal crystallites in the composite material will be enhanced. In the preferred embodiment, this functionalization is achieved by roughening the surface of at least some of the CNTs.

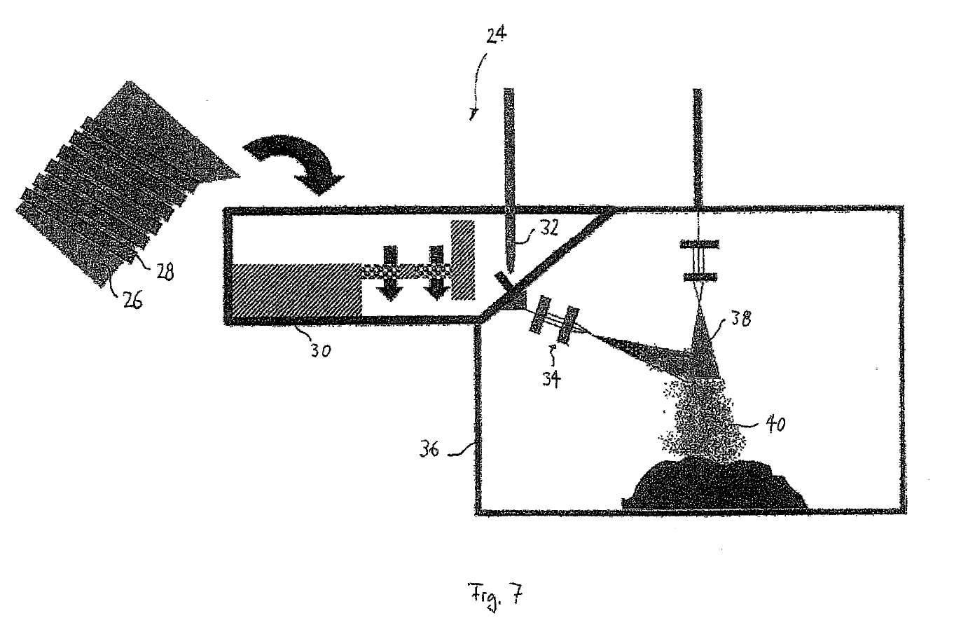

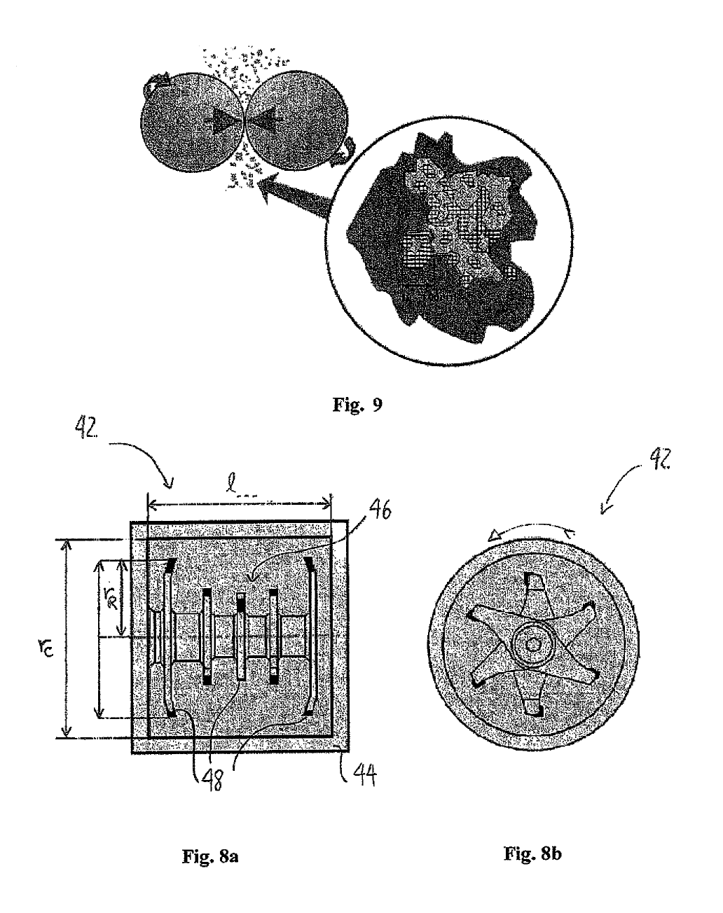

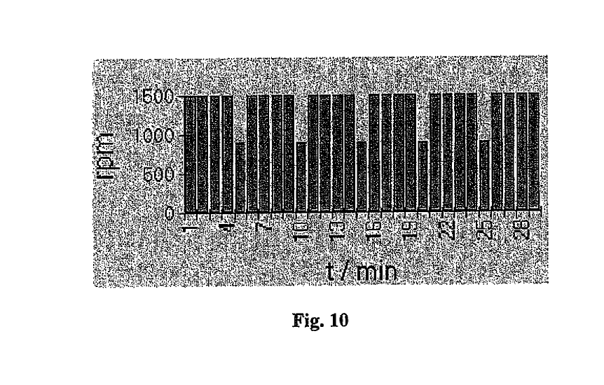

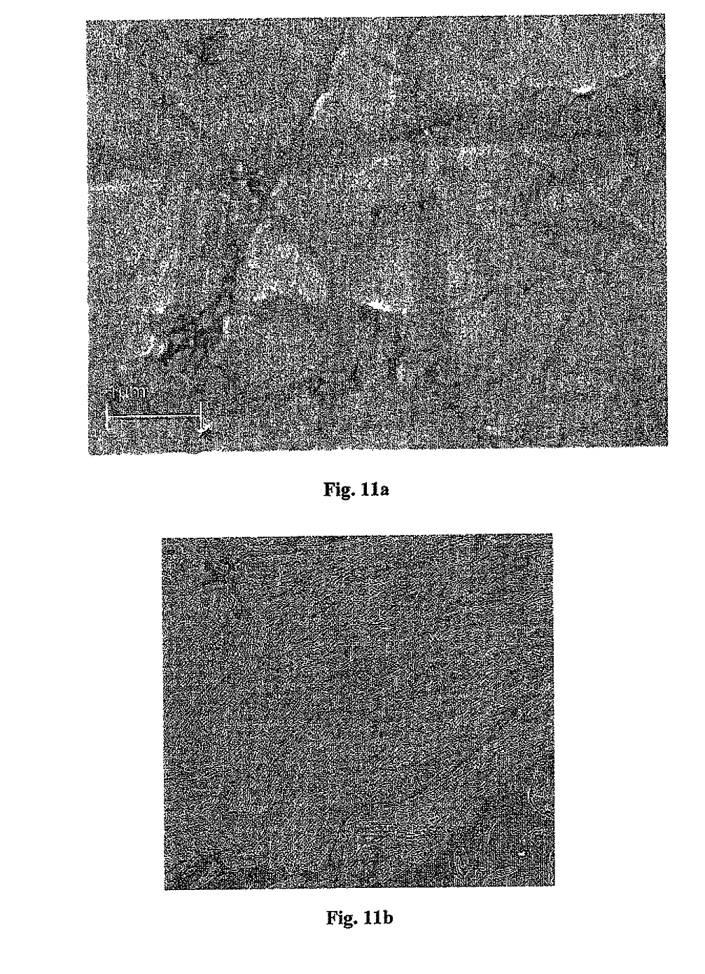

Herein, the CNT-agglomerates are submitted to a high pressure of 100 kg/cm² (9.8 MPa). Upon exerting this pressure, as is shown in FIG. 6b, the agglomerate structure as such is preserved, i.e. the functionalized CNTs are still present in the form of agglomerates preserving the aforementioned advantages with respect to low respirable dustiness and easier handling. Also, it is found that while the CNT retain the same inner structure, the outermost layer or layers burst or break, thereby developing a rough surface, as is shown in FIG. 6c. With the rough surface, the interlocking effect between CNT and crystallites is increased, which in turn increases the nano-stabilization effect.

### 3. Metal Powder Generation Through Atomization

In FIG. 7, a setup 24 for generating a metal powder through atomization is shown. The setup 24 comprises a vessel 26 with heating means 28 in which a metal or metal alloy to be used as a constituent of the composite of the invention is melted. The liquid metal or alloy is poured into a chamber 30 and forced by argon driving gas, represented by an arrow 32 through a nozzle assembly 34 into a chamber 36 containing an inert gas. In the chamber 36, the liquid metal spray leaving the nozzle assembly 34 is quenched by an argon quenching gas 38, so that the metal droplets are rapidly solidified and form a metal powder 40 piling up on the floor of chamber 36. Such a kind of powder forms the metal constituent of the composite material of the invention.

### 4. High Energy Milling of Metal Powders and Mechanical Dispersion of CNT in Metal

For the production of the inventive composite material from the CNT as described in section 1 and optionally functionalized as described in section 2 and from the metal powder optionally produced as described in section 3, the CNTs need to be dispersed within the metal. For the dispersion of the CNT's, a high energy ball mill similar as disclosed in DE 196 35 500, DE 43 07 083 and DE 195 04 540 A1 is used. The dispersion is achieved by using the mechanical alloying technique which is a process where powder particles are treated by repeated deformation, fracture and welding by highly energetic collisions of grinding balls. Ball velocities of advantageously above 4 m/s or even above 11 m/s or between 11-14 m/s are necessary. In a preferred embodiment, a process as disclosed in EP 1918249 A1, paragraphs [001-0013], is used. In the course of the mechanical alloying, the CNT-agglomerates are deconstructed and the metal powder particles are fragmentized, and by this process, single CNTs are dispersed in the metal matrix. In a further preferred embodiment, the mechanical alloying is carried out until the average length of the single CNT's is in the order of magnitude of the average size or average diameter of the metal crystallites, e.g. higher than 100 nm and up to 200 nm, preferably between 120 nm and 200 nm.

Using this type of process and the CNT according to the invention, a CNT-metal compound having a crystallite size between more than 100 nm and up to 200 nm, preferably between 120 nm-200 nm, will be formed. Also observed is a work hardening effect due to an increase of dislocation density in the crystallites. The dislocations accumulate, interact with each other and serve as pinning points or obstacles that significantly impede their motion. This again leads to an increase in the yield strength σ_{y} of the material and a subsequent decrease in ductility.

As regards the integrity of the disentangled CNTs in the metal matrix, it is believed that using the agglomerates of the CNT-INV according to the invention is advantageous, since the CNTs inside the agglomerates are to a certain extent protected by the outside CNTs.

However, many metals, in particular light metals such as aluminum have a fairly high ductility which makes processing by high energy milling difficult. Due to the high ductility, the metal may tend to stick at and bake to the inside wall of the milling chamber or the rotating element and may thereby not be completely milled. Such sticking can be counteracted by using milling aids such as stearic acids, alcohol or the like. The use of a milling agent may be avoided when using CNTs, as is explained in WO 2009/010297 by the same inventors, because the CNT itself may act as a milling agent which avoids sticking of the metal powder.

By the above described process, a powder composite material can be obtained in which metal crystallites having a high dislocation density and are at least partially separated and micro-stabilized by homogeneously distributed CNTs. FIG. 11a shows a cut through a composite material particle according to an embodiment of the invention. In FIG. 11a, the metal constituent is aluminum and the CNTs are of the multi-scroll type obtained in a process as described in section 1 above. The average length of the CNTs is in the range of the average size of the metal crystallites. In contrast to this, the composite material of WO 2008/052642 shown in FIG. 11b has a non-isotropic layer structure, leading to non-isotropic mechanical properties.

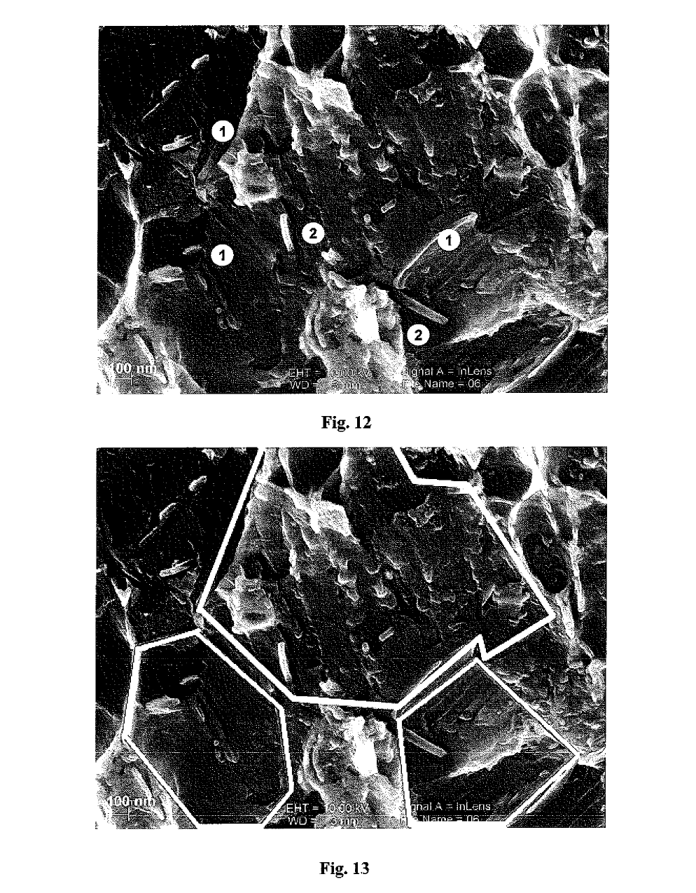

FIG. 12 shows an SEM image of a composite material comprised of aluminum with CNT dispersed therein. At locations denoted with number \textcircled{1}, examples of CNT extending along a boundary of crystallites can be seen (see also FIG. 13). At locations marked with reference signs \textcircled{2}, CNTs can be seen which are contained or embedded within a nanocrystallite and stick out from the nanocrystallite surface like a “hair”. It is believed that these CNTs have been pressed into the metal crystallites like needles in the course of the high energy milling described above. It is believed that these CNTs embedded or contained within individual crystallites play an important role in the nano-stabilization effect, which in turn is responsible for the superior mechanical properties of the composite material and of compacted articles formed thereby.

### 5. Compacting of the Composite Material Powder

The composite material powder can be used as a source material for forming semi-finished or finished articles by powder metallurgic methods. In particular, it has been found that the powder material of the invention can very advantageously be further processed by cold isostatic pressing (CIP) and hot isostatic pressing (HIP). Alternatively, the composite material can be further processed by hot working, powder milling or powder extrusion at high temperatures up to the melting temperature of some of the metal phases. It has been observed that the viscosity of the composite material even at high temperatures is increased such that the composite material may be processed by powder extrusion or flow pressing. Also, the powder can be directly processed by continuous powder rolling.

It is a remarkable advantage of the composite material of the invention that the beneficial mechanical properties of the powder particles can be maintained in the compacted finished or semi-finished article. For example, when using multi-scroll CNT and Al5xxx, by employing a mechanical alloying process as described in section 4 above, a composite material having a Vickers hardness of more than 390 HV was obtained. Remarkably, even after compacting the powder material to a finished or semi-finished product, the Vickers hardness remains at more than 80% of this value. In other words, due to the stabilizing nano structure, the hardness of the individual composite powder particles can largely be transferred to the compacted article.

Although a preferred exemplary embodiment is shown and specified in detail in the drawings and the preceding specification, these should be viewed as purely exemplary and not as limiting the invention. It is noted in this regard that only the preferred exemplary embodiment is shown and specified, and all variations and modifications should be protected that presently or in the future lie within the scope of protection of the appending claims.

1-15. (canceled)

16. A composite material comprising metal crystallites and nanoparticles, wherein the metal crystallites have an average size in the range of more than 100 nm and up to 200 nm.

17. The composite material of claim 16, wherein the metal crystallites have an average size in the range of between 120 nm and 200 nm.

18. The composite material of claim 16, wherein the nanoparticles are formed by CNTs, at least a fraction of which having a scroll structure comprised of one or more rolled up graphite layers, each graphite layer consisting of two or more graphene layers on top of each other.

19. The composite material of claim 16, wherein said nanoparticles are formed by carbon nano tubes (CNT) provided in form of a powder of tangled CNT agglomerates having a cluster size larger than 100 μm.

20. The composite material of claim 16, wherein the mean diameter of the CNT agglomerates is between 0.05 and 5 mm, preferably between 0.1 and 2 mm and most preferably between 0.2 and 1 mm.

21. The composite material of claim 16, wherein the length to diameter ratio of the nanoparticles, in particular CNTs, is larger than 3, preferably larger than 10 but most preferably smaller than 15.

22. The composite material of claim 16, wherein the length of the CNTs in the order of magnitude of the average size or average diameter of the metal crystallites.

23. The composite material of claim 22, wherein the average length of the CNTs in the composite is in the range of more than 100 nm and up to 200 nm.

24. The composite material of claim 16, wherein the CNT content of the composite material by weight is in a range of 0.5 to 10.0%, preferably 3.0 to 9.0% and most preferably 5.0 to 9.0%.

25. The composite material of claim 16, comprising a step of functionalizing, in particular surface roughening at least a fraction of the nanoparticles prior to the mechanical alloying.

26. The composite material of claim 25, wherein the nanoparticles are formed by multi-wall or multi-scroll CNTs and the roughening is performed by causing at least the outermost layer of at least some of the CNTs to break by submitting the CNTs to high pressure, in particular, a pressure of 5.0 MPa or higher, preferably 7.8 MPa or higher.

27. The composite material of claim 16, wherein nanoparticles are partly embedded in at least some of the crystallites.

28. The composite material of claim 16, wherein the metal is a light metal, in particular Al, Mg, Ti or an alloy including one or more of the same, Cu or a Cu alloy.

29. Use of the composite material according to claim 16 for the production of semi-finished or finished products.

30. Method of production of a composite material according to claim 16 comprising the step of mechanical alloying a metal and carbon nanotubes by high energy milling.
